(19) United States
(12) Patent Application Publication
(10) Pub. No.: US 2008/0063451 A1
(43) Pub. Date: Mar. 13, 2008

(54) IMAGE FORMING SYSTEM

(75) Inventors: Daisaku Kamiya, Abiko-shi (JP); Takeo Yamamoto, Abiko-shi (JP); Shigeo Hata, Toride-shi (JP); Mitsuhiro Ota, Toride-shi (JP); Naohisa Nagata, Moriya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/846,167

(22) Filed: Aug. 28, 2007

(30) Foreign Application Priority Data
Sep. 11, 2006 (JP) 2006-245242

(51) Int. Cl. G03G 15/00

(52) U.S. Cl. 399/395

(57) ABSTRACT

In an image forming system having an image forming apparatus main body for forming an image on a sheet and a sheet processing apparatus having a processing portion for processing sheets received from the image forming apparatus main body, sheets are conveyed to the sheet processing apparatus during an operation before starting of an image forming operation of the image forming apparatus main body or interruption of the image forming operation, and the sheet processing apparatus performs a calibrating operation on respective processing portions using the sheets received from the image forming apparatus main body.

### BACKGROUND OF THE INVENTION

1. Field of the Invention

The present invention relates to an image forming system which has an image forming apparatus which forms an image on a sheet and a sheet processing apparatus which processes sheets received from the image forming apparatus.

2. Description of the Related Art

Conventionally, image forming systems which have an image forming apparatus which forms an image on a sheet and a sheet processing apparatus which processes sheets received from the image forming apparatus are proposed. In such image forming systems, the image forming apparatus forms images on a sheet, the sheets on which the images are formed are sent to the sheet processing apparatus. The sheet processing apparatus selectively executes a predetermined process on the sent sheets.

The sheet processing apparatus in such image forming systems has various processing portions which execute processes such as aligning, binding and folding on sheets as the need arises. For this reason, the sheet processing apparatus conveys sheets and simultaneously performs a calibrating operation on the processing portions using the sheets. The calibrating operation is an adjusting operation for maintaining the processing portions in a state that they exercise processing abilities.

US PUB 2005/0082734 discloses an image forming system in which a finisher as the sheet processing apparatus is mounted to a printer as the image forming apparatus. The publication also describes that when covers of the printer and the finisher are opened or when the printer stops due to jam of sheet and shortage of toner, the finisher does not stop but continues to operate. Further, it is also disclosed in the publication that a path is separately provided so that the processing ability of the finisher is adjusted (calibrated). The path is for conveying not a sheet feeding portion provided to the printer but sheets temporarily placed on an externally attached sheet stacking portion.

In the conventional image forming systems, however, when the calibrating operation is performed, sheets cannot be conveyed from the image forming apparatus to the sheet processing apparatus in the following states. For example, when the image forming apparatus is performing a warming-up operation at the time of turning ON the power before starting of an image forming operation, sheets cannot be conveyed to the sheet processing apparatus. When the image forming apparatus is interrupting the image forming operation due to shortage of toner or the like, sheets cannot be conveyed to the sheet processing apparatus.

US PUB 2005/0082734 does not disclose that during the warming-up operation before the starting of the image forming operation or the interruption of the image forming operation, sheets are fed from the printer to the finisher and the processing ability of the finisher is adjusted (calibrated).

For this reason, even when the sheet processing apparatus requires the calibrating operation, in the above situation of the image forming apparatus, the sheet processing apparatus cannot be calibrated until the image forming apparatus returns from interruption or is actuated. That is to say, in the conventional image forming systems, it takes a long time to maintain the entire image forming systems, and the downtime of the systems are long.

### SUMMARY OF THE INVENTION

The present invention can shorten the time required for maintenance of an entire image forming system and reduce the downtime of the system.

According to a typical constitution of the present invention for achieving the above object, an image forming system includes: an image forming apparatus which has an image forming portion which forms an image on a sheet; and a sheet processing apparatus which has a processing portion which processes sheets received from the image forming apparatus. Sheets are conveyed to the sheet processing apparatus during an operation before starting of an image forming operation or interruption of the image forming operation of the image forming apparatus, and the sheet processing apparatus performs a calibrating operation in order to adjust the processing portion using the sheets received from the image forming apparatus.

According to the present invention, even when the image forming apparatus is not restored nor actuated, the calibration operation can be performed on the processing portion of the sheet processing apparatus during the operation before the starting of the image forming operation of the image forming apparatus and interruption of the image forming operation. Therefore, maintenance time of the entire image forming system can be shortened, and downtime of the system can be reduced.

### BRIEF DESCRIPTION OF THE DRAWINGS

FIG. 1 is a sectional view illustrating an entire constitution of an image forming system;

FIG. 2 is a sectional view illustrating a sheet processing apparatus;

FIG. 3 is a block diagram illustrating a control system of the image forming system;

FIG. 4 is a flowchart illustrating a flow of a sequence to a calibrating operation;

FIGS. 5A and 5B are explanatory diagrams illustrating an adjusting operation of processing portions;

FIG. 6 is an explanatory diagram illustrating an adjusting operation of a processing portion;

FIG. 7 is an explanatory diagram illustrating an adjusting operation of a processing portion; and

FIG. 8 is an explanatory diagram illustrating an adjusting operation of a processing portion.

### DETAILED DESCRIPTION OF THE PREFERRED EMBODIMENTS

Exemplary embodiments of the present invention are described in detail below with reference to the drawings. Dimensions, materials, shapes and relative arrangements of components described in the following embodiments should be suitably changed according to constitutions and various conditions of the apparatus the present invention pertains. The scope of the present invention is, therefore, not limited only to the embodiments unless otherwise particularly noted.

### First Embodiment

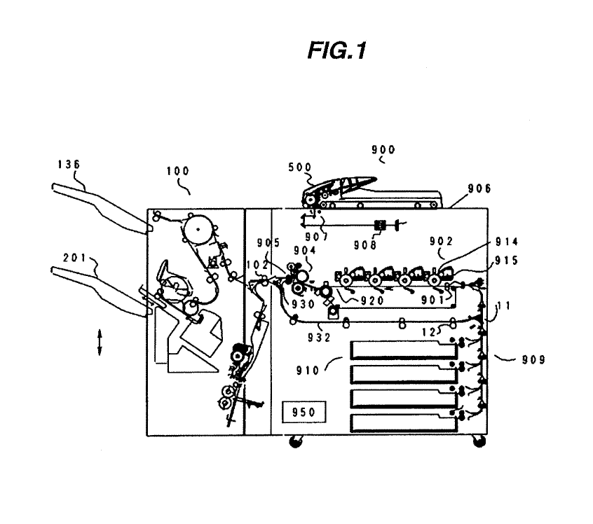

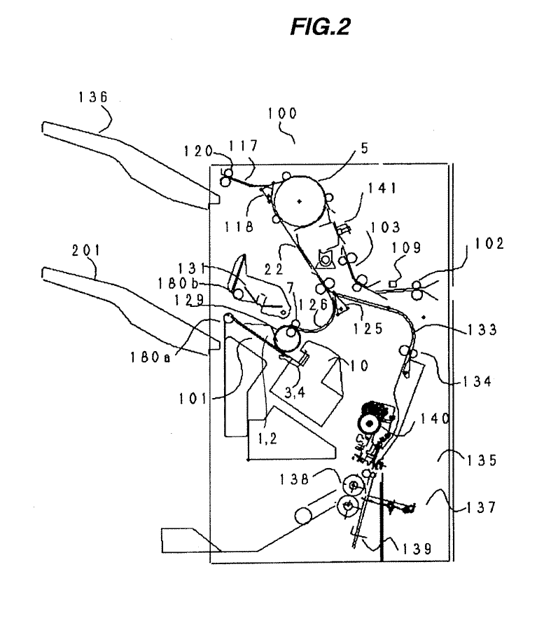

The entire constitution of an image forming system is described with reference to FIG. 1, and a sheet processing apparatus is described with reference to FIG. 2.

As shown in FIG. 1, the image forming system includes an image forming apparatus main body 900 and a sheet processing apparatus 100. The image forming apparatus main body 900 forms an image on a sheet. The sheet processing apparatus 100 processes sheets received from the image forming apparatus main body 900.

The image forming apparatus main body (copying machine main body) 900 has a platen glass 906 as an original placing platen, a light source 907, and a lens system 908 as an image reading portion which reads an image of an original. Further, the image forming apparatus main body 900 has a feeding portion 909 serving as a sheet feeding portion which feeds sheets one by one and an image forming portion 902 which forms images on the sheet. An automatic original feeding apparatus 500 which feeds an original to the platen glass 906 is mounted to the apparatus main body 900.

The feeding portion 909 has a plurality of cassettes 910 which store recording sheets and are detachable from the apparatus main body 900. The image forming portion 902 has photoconductive drums 914 as image bearing members and development devices 915 as process units to be use for the drums according to respective colors (four colors including YMCB). A conveyance device 920, a fixing portion 904 and a discharge roller pair 905 are disposed on a lower stream side of the image forming portion 902.

An operation of the image forming apparatus main body is described. When a feeding signal is output from a control device 950 provided to the side of the apparatus main body 900, a sheet is fed selectively from the cassettes 910. On the other hand, light, which is emitted from the light source 907 and reflects from an original placed on the original placing platen 906, is emitted to the photoconductive drums 914 via the lens system 908. The photoconductive drums 914 are charged by a primary charger in advance. When light is emitted to the photoconductive drums 914, electrostatic latent images are formed, and the development devices 915 develop the electrostatic latent images so as to form toner images.

Skew feeding of the sheet fed from the cassettes 910 by the feeding portion 909 is corrected by a registration roller 901, and their timing is adjusted so that the sheet is fed to the image forming portion 902. In the image forming portion 902, the toner image on the photoconductive drums 914 is transferred by a transfer charger onto the fed sheet. The sheet onto which the toner image is transferred is charged so as to have opposite polarity to that of the transfer charger by a separating charger, and the sheet is separated from the photoconductive drums 914.

The separated sheet is conveyed to the fixing portion 904 by the conveyance device 920, and transfer image is permanently fixed to the sheet by the fixing portion 904. The sheet to which the image is fixed are discharged from the apparatus main body 900 by the discharge roller pair (discharge portion) 905 in a straight discharge mode or a reverse discharge mode. In the straight discharge mode, the image surface of the sheet face up. In the reverse discharge mode, after the images are fixed, the sheet is conveyed to a sheet reverse path 930 and the sheet is reversed so that the image surface face down. When a duplex mode is specified, image is fixed to sheet where the image is formed on their one side, and the sheet is switched back in the reverse path 930. The sheet is then conveyed to a duplex path 932 and is again conveyed to the image forming portion 902 in order to form image on their other side. The image forming portion 902 forms image on the sheet fed from the cassettes 910 by the feeding portion 909, and the sheet is discharged to the sheet processing apparatus 100.

The sheet processing apparatus 100 is described below with reference to FIG. 2. The sheet processing apparatus suitably has various processing portions which execute aligning, binding and folding processes on sheets as the need arises. The sheet processing apparatus has a punch unit 141, a buffer unit 5 and aligning plates 1 and 2 as the processing portions for processing sheets. The punch unit 141 punches predetermined positions of sheet. The buffer unit 5 temporarily stores a plurality of sheets. The aligning plates 1 and 2 align directions of sheets perpendicular to a conveyance direction. The sheet processing apparatus further has a saddle unit 135 which executes saddle stapling/saddle folding processes on a bundle of sheets. The processing portions of the sheet processing apparatus are not limited to the above-mentioned processing portions.

The sheet discharged from the image forming apparatus main body 900 is delivered to an inlet roller pair 102 of the sheet processing apparatus 100. At this time, simultaneously an inlet sensor 109 detects delivery timing of the sheet. In order to execute the punching process, when the sheet conveyed by the inlet roller pair 102 pass through a conveyance path 103, the punch unit 141 executes the punching process on predetermined positions of the sheet.

The sheet conveyed by the inlet roller pair 102 passes through the conveyance path 103, and when the sheets are discharged onto an upper tray 136, the sheet is led to an upper path conveyance path 117 by an upper pass switching flapper 118 so as to be discharged onto the upper tray 136 by upper discharge rollers 120.

When the sheet is not discharged onto the upper tray 136, the sheet is led to a bundle conveyance path 22 by an upper path switching flapper 118.

When the sheet led to the bundle conveyance path 22 is saddle-stapled, the sheet is conveyed to a saddle path 133 by a saddle pass switching flapper 125 and is led to the saddle unit 135 by a saddle inlet roller pair 134. A front end stopper 139 aligns the conveyance direction of the sheet led by the saddle unit 135. When the saddle unit 135 aligns the predetermined number of sheets, a saddle-stapler 140 executes a saddle stapling process on a center portion of the bundle of sheets in the conveyance direction. The saddle-stapled bundle of sheets is guided downward by a front end stopper 139, and the stapled position at the center of the bundle of sheets is butted against the pushing plate 137 so as to be held between folding rollers 138. The folding rollers 138 fold the bundle of sheets and simultaneously discharge the bundle of sheets.

On the other hand, when the sheet led to the bundle conveyance path 22 is discharged onto a lower tray 201, the sheet is conveyed to a lower path 126 by the saddle path switching flapper 125. Thereafter, the sheet discharged onto a processing tray 101 by a lower discharge roller pair 7 is aligned by return members such as a puddle 131 and a knurling belt 129 and rear end stoppers 3 and 4 as aligning members in the conveyance direction. The aligning plates 1 and 2 which can move to a widthwise direction perpendicular to the conveyance direction of the sheet align the widthwise direction of the sheet. After the predetermined number of the sheets are aligned on the processing tray 101, the stapler 10 staples the bundle of sheets as the need arises. The bundle of sheets is discharged onto the lower tray 201 by a bundle discharge roller pair 180.

The buffer unit 5 temporarily stores the sheets which are fed from the image forming apparatus main body 900 to the sheet processing apparatus 100 at the time of the saddle stapling process/saddle folding process by means of the saddle unit 135 and the aligning and binding processes on the processing tray 101. When the processes in the respective units are completed, the several number of sheets stored in the buffer unit 5 are fed to the respective units.

<Control System of the Image Forming System>

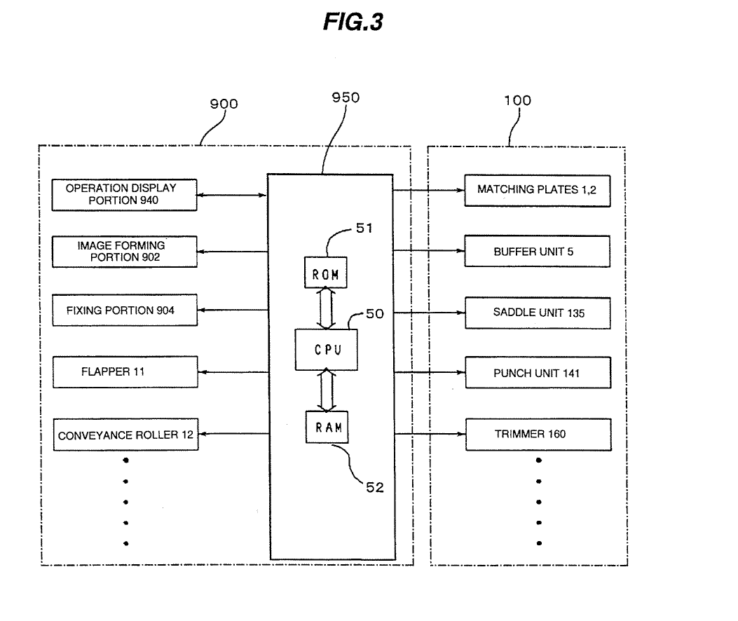

The control system in the image forming system is composed of a microcomputer system as shown in FIG. 3. In the image forming system, a control device (microcomputer system) 950 as a controller which controls the entire system is provided to the side of the image forming apparatus main body 900. In FIG. 3, the microcomputer system is composed of a CPU 50, a ROM 51 and a RAM 52. An image processing program and a post-processing program are stored in the ROM 51 in advance. The CPU 50 executes the respective programs and transmits/receives data suitably with the RAM 52 and simultaneously executes an input data process so as to create a predetermined control signal.

In such a system, signals from an operation display portion 940 on the side of the image forming apparatus main body and respective detecting sensors on the sides of the image forming apparatus main body and the sheet processing apparatus are loaded as input data into the CPU 50 via an input interface circuit. The respective control signals from the CPU 50 are sent to the entire system via an output interface circuit. The sent control signals suitably control the operation display portion 940, the image forming portion 902, the fixing portion 904, and the sheet conveyance portion composed of the flapper 11 and the conveyance rollers 12 or the respective processing portions on the side of the sheet processing apparatus. In the control system shown in FIG. 3, only a part of the image forming system is illustrated, but the other parts are omitted.

A constitution where only the image forming apparatus main body 900 has a control device 950 is illustrated, but the present invention is not limited to this. For example, a controller is provided to the image forming apparatus main body 900, and a controller is provided also to the sheet processing apparatus 100. The controllers are connected by communication so that data may be transmitted therebetween.

In the image forming system, when the power of the image forming system is turned ON (or the image forming operation is interrupted), a screen showing whether the sheet processing apparatus 100 is calibrated is displayed on the operation display portion 940. When necessity of the calibration of the sheet processing apparatus 100 is commanded via the operation display portion 940, the control device 950 executes the calibrating operation on the sheet processing apparatus 100. At this time, even when the warming-up operation before the starting of the image forming operation such as temperature adjustment of the fixing portion 904 is being performed or the image forming operation is being interrupted due to shortage of toner, the calibrating operation is executed on the sheet processing apparatus 100. Its details are described later.

<Calibration of the Sheet Processing Apparatus>

One example of the calibration of the processing ability of the sheet processing apparatus 100 is described below. The calibrating process of the processing portions using sheets in the sheet processing apparatus 100 is an adjusting operation for maintaining the processing portions in a state that they can exercise the processing abilities.

The reason why the calibrating operation of the processing portions using sheets is necessary is described. In general, the image forming apparatus main body 900 and the sheet processing apparatus 100 are mass-produced so as to have the same specifications, but the individual apparatuses always have production errors (integration error and assembly error of the components). Therefore, the level of influences (shift in the conveyance direction and the widthwise direction) of the production errors to be exerted on the image formation and the sheet process cannot be acquired unless sheets are conveyed to the individual apparatuses one by one. For this reason, sheets to be actually used for the image formation and the sheet process are fed from the cassettes 910 by the feeding portion 909 and the processing portions are adjusted (calibrated), so that the processing portions can be maintained in a state that they can exercise the processing abilities. Examples of the calibrating operation is concretely described below.

The calibrating operation of the sheet processing apparatus include (1) an operation for adjusting a gap of the aligning plates in the processing tray, (2) a buffer unit adjusting operation, (3) a saddle-stapling position/folding position adjusting operation of the saddle, (4) a punch position adjusting operation, and (5) a cutting position adjusting operation. The respective adjusting operations are described below.

(1) The Adjustment of Gap of the Aligning Plates in the Processing Tray

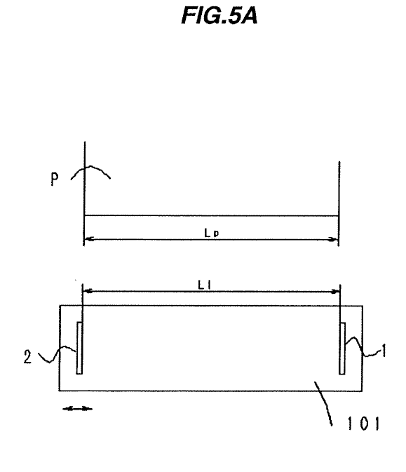

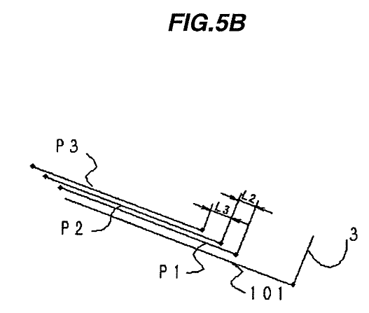

FIG. 5A illustrates the aligning gap of the aligning plates 1 and 2. Normally, the gap of the aligning plates L1 desirably aligns with a paper width Lp in a direction perpendicular to the conveyance direction of sheets P, and when they are different from each other, defective aligning such as aligning error occurs. However, even when the paper width Lp of the sheets P is the uniform standardized size (for example, A4 size), the actual dimension of individual sheets to be conveyed occasionally varies due to cutting error, an influence of environment and the like. For this reason, it is important for heightening consistency to adjust the gap L1 of the aligning plates according to the actual width Lp of sheets to pass therethrough. In the aligning plate calibrating operation, sheets are actually conveyed to the sheet processing apparatus 100, and the gap L1 of the aligning plates is adjusted by using the sheet. For example, the actual width Lp of the sheets to be conveyed to the sheet processing apparatus 100 is detected, and a waiting position at the time of the aligning of the aligning plates is changed accordingly so that the gap L1 of the aligning plates can be adjusted. The adjustment is not limited to this, and the gap between the aligning plates and the sheets in the waiting position or a deflection of the sheets in the aligning position is actually checked so that the adjustment may be carried out.

(2) Adjustment of the Buffer Unit

When the binding process and the saddle process are executed in the above manner, it is normally known that a certain length of the processing time is required. The time required for the processes partially depends on the image forming speed of the image forming apparatus, but the time is generally longer than a normal interval of sheet feeding to the sheet processing apparatus. For this reason, the sheet processing apparatus executes a so-called sheet buffer process so that the sheet process can be executed without interrupting the image forming operation of the image forming apparatus. Concretely, in the buffer unit 5 shown in FIG. 2, during the binding process and the saddle process on a foregoing bundle of sheets, a plurality of sheets from the head of a following bundle of sheets are temporarily stored, so that the time required for the process of the foregoing bundle of sheets is gained.

The plurality of buffered sheets (three sheets) is allowed to abut the rear end stopper 3 by a return member as shown in FIG. 5B so that their conveyance direction is aligned. The three sheets P1, P2 and P3 are superposed with a predetermined offsets L2 and L3 in the conveyance direction, so that the consistency is maintained. That is to say, it is important to adjust the buffer unit 5 so that the offsets have a predetermined value. The adjusting operation is enabled by actually conveying sheets from the apparatus main body 900 to the sheet processing apparatus 100. For example, the front end of the sheet P3 superposed on the sheets P1 and P2 and discharged in the conveyance direction and a rear end of the sheet P1 in the conveyance direction are detected. The entire length of the overlapped three sheets is calculated so that the actual offset can be obtained.

(3) Adjustment of Saddle Stapling Position/Folding Position of the Saddle Unit

When the above saddle process is executed, sheets conveyed to the saddle unit 135 are butted against the front end stopper 139 and the conveyance direction is aligned. When sheets are sequentially fed and the predetermined number of sheets are stacked, the bundle of sheets is saddle-stapled by the saddle-stapler 140. The front end stopper 139 which can move up and down descends by a predetermined amount, and the center of the bundle of sheets (saddle-stapled portion) is pushed by the pushing plate 137. The bundle of sheets is subject to the folding process by the folding rollers 138 and is stacked on the tray.

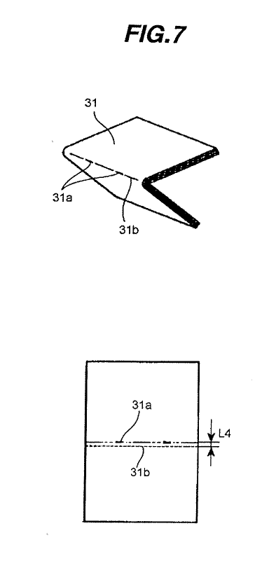

A stapled position 31a and a folded portion 31b are originally in the same position (L4=0), and are desirably at the center of the bundle of sheets 31. As shown in FIG. 7, however, the stapled position 31a and the folded position 31b of the bundle of sheet 31 occasionally shift by a length L4 according to the lengths of the sheets in the conveyance direction. In order to align these positions, it is desirable that the positions are adjusted according to the sheets. Concretely, sheets are conveyed to the sheet processing apparatus 100, and the position of the front end stopper 139 (waiting position at the time of the saddle stapling process (aligning position)) and its descending amount after the saddle stapling are calibrated by using the sheets. Also in this case, the actual length in the conveyance direction of the sheets conveyed to the sheet processing apparatus 100 is detected so that the position of the front end stopper 139 can be adjusted. In another manner, the shift between the stapled position 31a and the folded position 31b may be visually inspected directly so as to be adjusted.

(4) Adjustment of Punching Position

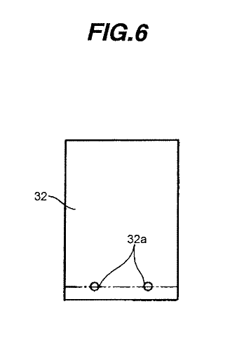

FIG. 2 illustrates the punch unit 141. The punch unit 141 punches a predetermined position of a sheet 32 conveyed to the sheet processing apparatus 100. The sensor 109 detects a front end or a rear end of the conveyed sheet 32, and the punch unit 141 is operated at predetermined timing based on the detected data, so that the punch unit 141 punches the sheet 32. As shown in FIG. 6, punching positions 32a can be made to be variable according to user's desire. Even when predetermined positions are selected, however, the positions are not accurately reproduced and occasionally shift depending on the length of the sheet 32 in the conveyance direction. In order to improve the accuracy, it is necessary to calibrate the punching positions according to sheets. Sheets are actually used and are detected by the sensor 109, and the timing up to the punching is adjusted. As a result, desirable punching positions can be punched.

(5) Adjustment of Cutting Position

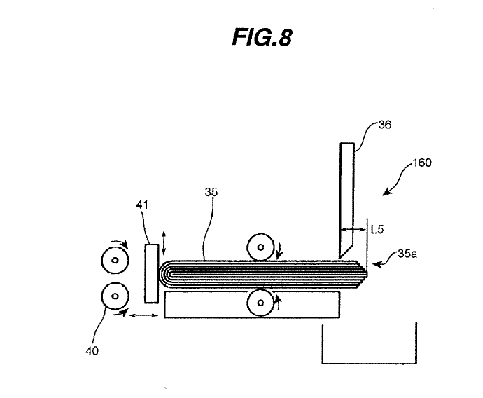

FIG. 8 illustrates a trimmer 160 which cuts edges of the saddle-processed bundle of sheets. In the sheet processing apparatus shown in FIGS. 1 and 2, the trimmer is not illustrated, but it goes without saying that the trimmer as the processing portion can be provided suitably as the need arises.

The cut edge 35a of a saddle-processed bundle of sheets 35 normally gets pointed. In order to improve the product quality, the cut edge 35a of the bundle of sheets 35 is cut by the trimmer 160. The bundle of sheets 35 fed by the trimmer 160 is butted against the front end stopper 41, and a cutter 36 cuts it by a predetermined amount. Thereafter, the front end stopper 41 retreats, the bundle of sheets 35 is fed to the conveyance rollers 40 so as to be stacked on the tray, not shown.

The cutting amount L5 of the cut edge 35a of the bundle of sheets 35 can be changed according to user's desire by moving the position of the front end stopper 41 to a direction parallel with the bundle conveyance direction. Even when the position of the front end stopper is selected so that the cutting amount is changed, the position is not accurately reproduced and occasionally shifts depending on the length of sheets in the conveyance direction. In order to improve the accuracy, it is necessary that the cutting position is calibrated according to sheets. Concretely, sheets are actually used and the front end stopper 41 is moved to the conveyance direction of the bundle of sheets so that the waiting position at the time of cutting is adjusted. As a result, the cutting amount L5 can be adjusted.

The calibrating operation of the processing portions in the sheet processing apparatus 100 is described, but the present invention is not limited to this. For example, in the sheet processing apparatus having a processing portion other than the above processing portions for executing a case bookbinding process (cutting position, gluing amount, and folding position), it goes without saying that this processing portion is calibrated.

<Description of the Operation>

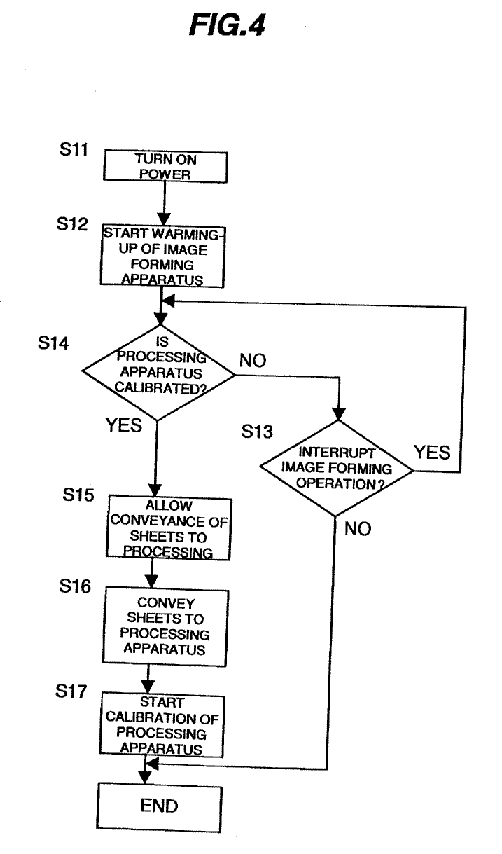

FIG. 4 is a flowchart for describing the operation for calibrating the processing portions in the sheet processing apparatus.

When power of the image forming apparatus is turned ON (step S11), the warming-up operation before the starting of the image forming operation such as temperature adjustment of the fixing portion 904 is started (step S12). At the same time, a screen of the operation display portion is actuated, and a screen whether the sheet processing apparatus is calibrated is displayed on the operation display portion (step S14). When the image forming operation is interrupted due to a reason such as shortage of toner (step S13), similarly the screen whether the sheet processing apparatus is calibrated is displayed on the operation display section (step S14).

When the necessity of the calibration of the sheet processing apparatus is commanded at step S14, even during the operation before the image forming operation or the interruption of the image forming operation, the operation for conveying sheets from the apparatus main body to the sheet processing apparatus is permitted (step S15). Sheets are conveyed from the image forming apparatus main body to the sheet processing apparatus (step S16), and the calibrating operation of the sheet processing apparatus are started by using the sheets (step S17).

In the calibrating operation for maintaining the processing portions in a state that they can exercise the processing abilities, the conveyance of sheets to the sheet processing apparatus is the essential condition. A constitution where the calibrating operation is enabled in the embodiment is such that even when the image forming operation using the toner cannot be performed, the operation for conveying sheets from the apparatus main body to the sheet processing apparatus is enabled during the operation before the image forming operation or the interruption of the image forming operation. For this reason, like the apparatus disclosed in US PUB 2005/0082734, the calibration can be carried out without providing a sheet feeding portion exclusive for the calibration.

The constitution is such that the calibration is set to be enabled or disabled on the operation display portion during the operation before the image forming operation or the interruption of the image forming operation. However, the present invention is not limited to this. For example, the constitution may be such that the calibration of the sheet processing apparatus is automatically carried out during the operation before the image forming operation or the interruption of the image forming operation.

The calibration which cannot be carried out without actually introducing sheets or requires a lot of time can be efficiently carried out. That is to say, the time required for the maintenance of the entire image forming system can be shortened, and the downtime of the system can be reduced.

### Other Embodiments

The above-mentioned embodiment describes the constitution where sheets to be used for the calibrating operation are conveyed to the sheet processing apparatus 100 via the image forming portion 902 and the fixing portion 904 in the image forming apparatus main body 900. However, the present invention is not limited to this.

For example, when sheets are conveyed from the image forming apparatus main body 900 to the sheet processing apparatus 100 for the calibration, the sheets may be conveyed to the sheet processing apparatus 100 not through the image forming portion 902 and the fixing portion 904.

That is to say, the image forming apparatus main body 900 has a sheet path for conveying the sheets fed from the cassettes 910 to the sheet processing apparatus 100 not through the image forming portion 902 and the fixing portion 904. Concretely, the fed sheets are sent to the both-face path 932 by the flapper 11, and are sent to the reverse path 930 by the conveyance rollers 12 which can rotate regularly and reversely. The sheets are conveyed to the sheet processing apparatus 100. The other parts of the constitution are similar to those in the aforementioned embodiment.

As a result, even while the image forming apparatus 900 is performing the warming-up operation or is interrupting the image forming operation due to the temperature adjustment of the fixing portion 904, shortage of toner and the other adjustments, sheets are conveyed to the sheet processing apparatus 100 not through the image forming portion 902 and the fixing portion 904. The sheets to be actually used are conveyed via the path without the image forming portion, so that the calibration of the sheet processing apparatus can be carried out accurately without damaging the fixing portion and the image forming portion. Therefore, the maintenance time of the entire system can be shortened, and the downtime of the system can be reduced.

When sheets are conveyed from the image forming apparatus main body 900 to the sheet processing apparatus 100 for the calibration, the pressure contact of a sheet holding portion in the image forming portion 902 and the fixing portion 904 may be released.

That is to say, when sheets are conveyed for the calibration, the photoconductive drums 915 and the conveyance device 920 in the image forming portion 902 are separated from each other, and the paired rollers in the fixing portion 904 are separated from each other. As a result, the pressure contact of the sheet holding portion is released. Thereafter, the sheets fed from the cassettes 910 are conveyed to the sheet processing apparatus 100 via the image forming portion 902 and the fixing portion 904. The other parts of the constitution are similar to those in the above embodiment.

When the pressure contact of the sheet holding portion in the image forming portion 902 and the fixing portion 904 is released, the fed sheets are conveyed from the apparatus main body 900 to the sheet processing apparatus 100 without damaging the fixing portion and the image forming portion. As a result, the sheet processing apparatus can be calibrated accurately by using the sheet to be actually used without damaging the fixing portion and the image forming portion. The maintenance time of the entire system and the downtime of the system can be reduced.

The above embodiment refers to the copying machine as the image forming apparatus, but the present invention is not limited to this. For example, another image forming apparatus such as a printer or a facsimile device or another image forming apparatus such as a complex machine where the functions of the printer and the facsimile device are combined may be used. The present invention is applied to the image forming system having such an image forming apparatus and the sheet processing apparatus, so that the same effect can be obtained.

In the above embodiment, the image forming system is constituted so that the sheet processing apparatus is mounted to the image forming apparatus main body, but the present invention is not limited to this. For example, the image forming apparatus main body may have the sheet processing apparatus integrally, and the present invention is applied to this image forming system so that the same effect can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-245242, filed Sep. 11, 2006, which is hereby incorporated by reference herein in its entirety.

What is claimed is:

1. An image forming system comprising:
an image forming apparatus which has an image forming portion which forms an image on a sheet; and
a sheet processing apparatus which has a processing portion which processes sheets received from the image forming apparatus,
wherein sheets are conveyed to the sheet processing apparatus during an operation before starting of an image forming operation or interruption of the image forming operation of the image forming apparatus, and the sheet processing apparatus performs a calibrating operation in order to adjust the processing portion using the sheets received from the image forming apparatus.

2. The image forming system according to claim 1, wherein when the sheets are conveyed to the sheet processing apparatus during the operation before the starting of the image forming operation or the interruption of the image forming operation, the image forming apparatus conveys sheet to the sheet processing apparatus via a sheet path without the image forming portion.

3. The image forming system according to claim 1, wherein the image forming apparatus has a fixing portion which fixes an image onto a sheet, and when the sheets are conveyed to the sheet processing apparatus during the operation before the starting of the image forming operation or the interruption of the image forming operation, the image forming apparatus conveys the sheets to the sheet processing apparatus via a sheet path without the image forming portion and the fixing portion.

4. The image forming system according to claim 1, wherein the image forming apparatus has a fixing portion which fixes an image onto a sheet, and when sheets are conveyed to the sheet processing apparatus during the operation before the starting of the image forming operation or the interruption of the image forming operation, pressure contact of a sheet holding portion in the image forming portion and the fixing portion is released.

5. The image forming system according to claim 1, wherein the calibrating operation of the processing portion using the sheets in the sheet processing apparatus is an adjusting operation for maintaining the processing portion in a state that they can exercise a processing ability.

6. The image forming system according to claim 1, further comprising:
a sheet feeding portion which feeds a sheet to the image forming portion,
wherein the sheet processing apparatus performs a calibrating operation using the sheets fed by the sheet feeding portion.

7. A sheet processing apparatus comprising:
a processing portion which processes sheets received from an image forming apparatus,
wherein sheets are conveyed to the processing portion during an operation before starting of an image forming operation or interruption of the image forming operation of the image forming apparatus, and a calibrating operation in order to adjust the processing portion is performed using the sheets received from the image forming apparatus.

8. An image forming apparatus comprising:
an image forming portion which forms an image on a sheet; and
a sheet feeding portion which feeds a sheet to the image forming portion,
wherein the sheet feeding portion conveys sheets, for a calibrating operation in order to adjust the processing portion, to a sheet processing apparatus having a processing portion which processes sheets received from the image forming apparatus during an operation before starting of an image forming operation or interruption of the image forming operation of the image forming apparatus.
